(19) United States
(12) Patent Application Publication
(10) Pub. No.: US 2026/0201970 A1
(43) Pub. Date: Jul. 16, 2026

(54) PRESSURE-RELIEVING VALVE

(71) Applicant: Friedrich MÜLLER, Neuenstadt (DE)

(72) Inventor: Udo KÖHLER, Forchtenberg (DE)

(21) Appl. No.: 19/577,894

(22) Filed: Mar. 25, 2026

Related U.S. Application Data
(63) Continuation of application No. PCT/EP2024/076951, filed on Sep. 25, 2024.

(30) Foreign Application Priority Data
Sep. 26, 2023 (DE) 10 2023 126 000.6

(51) Int. Cl. F16K 17/06; F16K 31/06

(52) U.S. Cl. CPC F16K 17/06; F16K 31/0655

(57) ABSTRACT

A valve includes at least one inlet and at least one outlet, a housing, and an actuator that is adjustable to at least a first end position in which the valve is closed, and to at least a second end position in which the valve is open. The valve includes a controller to adjust the actuator. The valve includes a valve seat which, in the first end position in which the valve is closed, bears sealingly against an outer surface of the actuator.

### CROSS REFERENCE TO RELATED APPLICATIONS

This application claims the benefit of priority to German Patent Application No. 10 2023 126 000.6 filed on Sep. 26, 2023 and is a Continuation Application of PCT Application No. PCT/EP2024/076951 filed on Sep. 25, 2024. The entire contents of each application are hereby incorporated herein by reference.

### BACKGROUND OF THE INVENTION

### 1. Field of the Invention

The present invention relates to valves, in particular, hydrogen valves, each including at least one inlet and at least one outlet, a housing, and an actuator located in the housing and adjustable to at least a first end position in which the valve is closed and at least a second end position in which the valve is open, and a controller to adjust the actuator. The present invention also relates to valve seats and support rings for such valves.

### 2. Description of the Related Art

Valves and coaxial valves have long been known and are commercially available. Known coaxial valves typically feature an adjustable actuator in the form of a shaft or a tube through which the medium to be controlled flows. In known solutions, the actuator interacts with a valve seat against which an end surface of the actuator bears. The seal is formed by the contact of the control tube with the valve seat, wherein the valve seat has a surface for this purpose against which the actuator is pressed when the valve is closed.

For example, DE 100 51 492 A1 discloses a flow control valve in the form of a coaxial valve with a control tube and a valve seat, in which a control tube is pressed against a substantially flat valve seat to close the valve.

However, there are different designs of valve seats. For example, DE 101 08 492 A1 discloses another coaxial valve with an actuator that interacts with a valve seat having a rounded seating surface.

The known valves have in common that sealing is achieved by the contact of the actuator with the valve seat. For this purpose, the end surface of the actuator is designed differently depending on the application and the material of the valve seat. Depending on the application, the aim is to ensure that the control tube is as pressure-relieved as possible in every position. For this purpose, the cross-section of the end surface may be, for example, tapered in the form of a collar, with the tip of the collar resting against a surface of the valve seat. Thus, an inclined section of the collar remains free, allowing the ambient pressure to act on this inclined surface. Since, by design, part of the end surface must still rest against the valve seat, known coaxial valves are only approximately and not completely pressure-relieved.

To complicate matters, the collar may need to be designed differently depending on the valve seat material. For example, the tip of the end surface can also be manufactured with an approximately round radius. Depending on the material of the valve seat, particularly its hardness, the tip can also penetrate more or less deeply into the valve seat or deform elastically upon contact. All of this affects the exact contact point and influences the switching and sealing behavior of the valve.

This results in the further disadvantage that the tip can deform depending on the pressure applied to the valve. For the collar or the exact contact point on the valve seat, it is generally crucial on which side of the control tube the pressure is applied. While the control tube may be nearly (but not completely) pressure-relieved on one side, it is subjected to strong pressure on the other side. Depending on the design of the collar or the control tube, the contact point shifts due to the applied sealing force or the deformation of the tip. This means that coaxial valves generally have a specified flow direction and thus a fixed installation orientation and/or are only partially backpressure-tight.

Another drawback of the known solutions is that the point where the actuator contacts the valve seat is subject to wear. This is particularly true when the end surfaces of the actuator are very pointed and when the valve seat is made of particularly inelastic and/or hard materials. To ensure that the seal functions reliably even with hard materials, the control tube must sometimes be pressed very firmly onto the seat. However, this is only possible to a certain extent, as otherwise the control tube would destroy either the valve seat or the tip of the control tube, much like a punching tool. Where the actuator contacts the seating surface of the valve seat when switching the valve, microscopic wear and/or damage can also occur due to mechanical stress on the material. This adversely affects the sealing performance of the valve, resulting in an overall deterioration of the valve's performance. This has a particularly detrimental effect when the valve is intended for use with very light gases such as hydrogen. The extremely small hydrogen atoms or _{H}2 molecules can pass through even the tiniest damage and leaks as soon as the valve seat exhibits a certain degree of wear. The valve thus becomes leaky and is consequently unsuitable for such applications.

However, hydrogen is currently becoming increasingly important, not least due to the development of new propulsion technologies in the automotive sector. As an extremely light gas, hydrogen places particularly high demands on the valves used. This applies especially when high pressures are involved, such as 500, 1000, 1500 bar, or even higher pressures. In this case, even the smallest leaks between the actuator and the valve seat cause the valve to no longer be tight. Consequently, high hydrogen pressures cannot be handled with conventional valves, or only with significant limitations.

To make matters worse, with conventional valves, the applied pressure always acts at least partially on the actuator when the valve is closed. Because the actuator is pressed against a valve seat at the front, the applied pressure effectively acts on the actuator as well, pressing the actuator further against the valve seat when the valve is closed. This is the case even with coaxial valves that are nearly pressure-relieved. This may require high actuation forces or high actuation pressures to open the valve again. This sometimes results in increased wear, which can further adversely affect the valve's sealing performance. Furthermore, the outlet and inlet of such valves are not interchangeable, or at least not without difficulty. This means they have a preferred flow direction.

### SUMMARY OF THE INVENTION

Example embodiments the present invention provide valves that do not exhibit the aforementioned disadvantages. In particular, valves according to example embodiments of the present invention operate reliably even at high pressures, including with hydrogen or other fluids.

According to an example embodiment of the present invention, a valve includes a valve seat which, in a first end position in which the valve is closed, bears sealingly against an outer surface of an actuator.

Because the valve includes a valve seat that, when the valve is closed, bears sealingly against an outer surface of the actuator, the sealing effect does not have to be achieved by the actuator bearing against a surface of the valve seat, or the bearing of the actuator against a surface of the valve seat can be entirely dispensed with. Thus, mechanical wear and tear on the surface of the valve seat can no longer limit and/or impair the sealing effect of the valve. Consequently, a valve according to an example embodiment of the present invention is also advantageously suitable for high contact pressures, particularly when using very light gases such as hydrogen. Also, a valve according to an example embodiment of the present invention and its mode of operation are also suitable for other fluids, such as other gases or liquids.

Further advantages are apparent from the subclaims.

In a particularly preferred example embodiment, the valve seat is a substantially annular body with an inner diameter that is suitable for receiving the actuator. When the valve is actuated, the actuator can, for example, be extended into or retracted from the annular body to close or open the valve. A contact surface, as found in conventional valves, can then be entirely dispensed with.

In another preferred example embodiment, the actuator includes a tubular body, specifically in the form of a hollow cylinder, including a wall that includes two ends and an outer surface, wherein the actuator includes an axially extending channel that opens at each of the ends of the actuator. Accordingly, a shaft or a tube with an internal channel, in which the ends of the body are arranged annularly around the openings of the channel, is particularly suitable as an actuator.

In one example embodiment, the first end of the actuator is seated sealingly in a first cylindrical recess of the housing in both the first and second end positions, in particular by seals, and the second end of the actuator is seated sealingly in a second cylindrical recess of the housing in both the first and second end positions, in particular by seals, wherein connecting channels terminate in the cylindrical recesses, which connect the recesses to the inlet and the outlet. The recesses of the housing may, for example, be bores into which the actuator protrudes or in which the actuator is seated.

In a particularly preferred example embodiment, the ends of the actuator do not come into contact with the inner wall of the respective recess in either end position, wherein, in particular, the first recess and/or the second recess each includes at least one, in particular conical, end wall. The end wall may, for example, be arranged on a wall of the respective recess opposite the actuator. The end wall may, for example, include a bore that is approximately several millimeters (e.g., about 3-5 mm) deep, such that the end or ends of the actuator do not come into contact with the inner wall of the recess but are completely exposed.

This example embodiment has the significant advantage that, when the valve is closed, the medium flows through the actuator and the pressure acts exactly equally on both ends of the actuator, provided the ends are of exactly the same size and type. Since the sealing effect of the valve is ensured by the valve seat surrounding the actuator, none of the ends of the actuator needs to come into contact with a valve seat. The applied pressure thus acts uniformly on the entire actuator, so that the actuator is not pushed in a preferred direction. The actuator is thus 100% or completely pressure-relieved. Consequently, the actuator can be actuated advantageously with comparatively low forces even at high applied pressures, e.g., at 2000 bar.

In a further example embodiment, the valve seat is arranged in the first recess. The valve may be designed such that the valve is closed when the actuator passes through the valve seat and is open when the actuator is not positioned in the valve seat.

In a particularly preferred example embodiment, in the first end position, the valve seat seals against the outer surface of the actuator, and in the second end position, the first end of the actuator is displaced axially away from the valve seat such that the actuator's channel communicates with the connecting channel. The valve is then closed in the first end position and open in the second end position.

In a further preferred example embodiment, the actuator is adjustable by a drive. This drive may, for example, be pressure-controlled by a control medium and/or may also be electromagnetically operated.

In a further example embodiment, the actuator includes a piston or a piston is fixedly connected to the actuator, and the piston is arranged in a third cylindrical recess of the housing, which is located in particular between the two recesses, and seals off two working chambers from one another, wherein the piston can be moved back and forth between its end positions by a control medium that can be introduced into the working chambers. The valve can then be actuated, for example, by filling each of the two working chambers with a control medium such as a control gas. Of course, other control media, such as a liquid, are also conceivable.

If one working chamber is filled with a control medium, the piston—and thus the actuator moves in such a way that the volume of the chamber increases. To move the actuator in the opposite direction, the other chamber is filled with the control medium accordingly. Naturally, the chambers must have appropriate inlets and outlets. It has surprisingly been discovered that even at very high applied pressures on the valve, such as 1000, 1500, or 2000 bar, for example, a low switching pressure of, for example, 5-10 bar is sufficient to switch the valve. This is due in particular to the fact that the actuator is 100% or completely pressure-relieved even when closed. Thus, the sealing force plays no role in actuating the valve. The actuation pressure need only overcome the friction of the actuator and, if applicable, the spring force of a spring.

In a further example embodiment, the body rests against a surface within the third recess in both the first end position of the actuator and the second end position of the actuator, such that these surfaces limit the axial adjustability of the actuator. In this way, the end positions of the actuator can be defined without the actuator's ends coming into contact with a surface inside the housing.

In a further example embodiment, the third recess is sealed off from the other two recesses by seals, in particular in the form of an O-ring, a pneumatic sealing edge, or a radial shaft seal. For example, the actuator may be partially arranged in or lie within the first, second, and third recesses. To this end, dynamic seals are present to seal the recesses from one another. These dynamic seals may be any type of seal that meets the requirements for sealing performance and wear resistance for the respective medium and pressure. In principle, piston and rod seals are conceivable, which are either fixedly arranged in the housing or fixedly arranged on the actuator and are driven along during adjustment.

In a particularly preferred example embodiment, at least one, and in particular two, sealing elements include a support ring and a groove ring, wherein the actuator is arranged in the sealing elements in a movable manner. The support ring may, in particular, be arranged in a recess provided for this purpose within the housing and be dimensioned such that it abuts both radially outwardly against a housing wall and radially inwardly against the actuator. As a result, the support ring can, on the one hand, support the seal in the form of a groove ring and simultaneously define a guide for the actuator. The groove ring can, for example, be slipped onto the support ring and define the seal, while the support ring automatically centers itself and holds the seal in position.

In principle, a design is also conceivable in which at least one sealing element is arranged on the actuator. This may be a piston seal. However, particularly when using thin gases, the requirements for the sealing surface are very high. In this design, therefore, great importance must be placed on the recess in which the piston seal is positioned.

In another example embodiment, the groove ring is made of a polyurethane such as H-ECOPUR. Such groove rings are commercially available and therefore easy to obtain.

In a particularly preferred example embodiment, the valve seat is made of or includes a high-performance plastic such as polyaryletherketone (PEEK), or includes a component made of such a high-performance plastic. This material is particularly suitable for the valve seat, as it meets the high requirements for processability, wear resistance, and sealing performance even in the presence of hydrogen.

In a further example embodiment, the valve is a coaxial valve, i.e., the inlet and outlet are located on a common axis. Naturally, the inlet and/or outlet of the valve or the corresponding channels must then be redirected, if necessary, to enable a coaxial connection. However, particularly with light gases such as hydrogen, such redirections pose little or no disadvantage with regard to the valve's performance.

In a further example embodiment, the inlet can also be used as an outlet, in which case the outlet can then be used as an inlet. This is particularly possible with fully pressure-relieved versions of the valve, since the actuator is not pushed into a specific position by the applied pressure when the valve is closed. Back pressure and sealing force no longer play a role in this example embodiment. It is therefore irrelevant for this valve on which side of the valve the pressure is applied. The valve is thus extremely flexible in its application, and incorrect installation, for example, with the flow direction reversed is not possible if the valve is designed appropriately.

In a further example embodiment, the valve additionally includes at least one channel that terminates between two sealing elements in the region of a recess and serves to monitor and measure leaks. In this way, leaks can be detected and, when using multiple channels, each corresponding to exactly one seal, can be assigned to a specific seal.

In a further example embodiment, the valve includes a spring that is directly or indirectly operatively connected to the actuator and holds the actuator in the first or second end position when no force or only a small force is exerted on the actuator by the drive. Force is understood here to mean the force exerted on the actuator to switch the valve. In particular, this can be the pressure of the control medium acting on the piston of the actuator.

Depending on the design and arrangement of the spring, the valve may be normally closed or normally open. Of course, the valve may also include a limit switch that monitors the valve's position.

In a further example embodiment, the actuator may additionally or alternatively include a magnet, so that the valve can also be opened or closed (electro-)magnetically. Naturally, in this configuration, the valve can be designed to be both normally open and normally closed.

In a valve according to an example embodiment of the present invention, more than two connections and more than two switching positions may also be provided. Thus, the inlet and/or the outlet may also include at least two connections. For example, the valve may include a total of three connections, wherein one of the connections defines the inlet and two connections each define an outlet. The valve may also include more than one inlet and/or more than one outlet, wherein the inlets and/or outlets may be interconnected in a wide variety of ways.

Different configurations of a valve can be created by varying the number and arrangement of sealing elements, seals, and ports, as well as by using different controllable switching positions of the actuator. For example, one port may define the inlet and two ports may define the outlet, with the valve being closed in one switching position of the actuator. In a second switching position, both ports defining the outlet may be open. In this example, the valve is configured as a possible 3/2-way valve.

However, it is also possible for one port to serve as an inlet and the other two ports to serve as outlets, with the actuator connecting the inlet to the first outlet in a first position and connecting the inlet to the second outlet in a second position. This is also a 3/2-way valve, but of a different type.

In the latter variant, a third position may also be provided in which the valve is closed. In this case, the valve is a variant of a 3/3-way valve.

It is also possible for two ports to define the inlet and one port to define the outlet. Here, too, different switching positions with different port configurations are of course possible. More than three ports are also possible, for example, 5/3-way valves.

The actuator may also be configured differently. For example, the actuator may include one or more openings on its wall, such as holes. These side openings can function as branches of the actuator's channel and offer the option for additional, more complex connections with further ports. Thus, the openings can each correspond to one or more ports, thus providing the possibility of additional switching positions for various configurations.

The actuator may, for example, include two or more openings, with each opening being assigned to exactly one connection. In a first switching position, the first connection may thus be activated, and in a second switching position, the second connection may be activated. This allows, among other things, the necessary switching distance that the actuator must travel to be shortened and/or multiple connections to be connected.

The actuator may also include multiple openings, wherein at least two openings have different cross-sections. Thus, the flow through one or more ports can be varied by having one opening allow a higher flow rate while another opening allows a lower flow rate. These openings may also correspond to one or more ports or to the same port, respectively.

In some variants, the actuator may include at least one opening that has a non-rotationally symmetric cross-section. By non-rotationally symmetric, a cross-section is specifically meant here whose shape changes relative to the corresponding port.

For example, the opening may have a substantially triangular cross-section, whereby in a first switching position only the apex of the triangle allows the fluid flow to the corresponding connection. As the actuator moves, the cross-section of the triangle opens up an increasingly larger flow opening, so that the flow to this connection becomes increasingly greater. In this manner, among others, a metering and/or control valve can be realized. It is also possible for the actuator, designed as a control tube, to not only move in the axial direction but also to rotate about its longitudinal axis to assume the various switching positions, whereby the corresponding drives and, if necessary, gearboxes are provided. For example, it is conceivable that the control tube has a partial or complete circumferential toothing on its cylindrical outer wall to rotate the control tube about its axis. Additionally, an axial adjustment drive may be provided.

An example embodiment of the present invention also relates to a valve seat for a valve according to an example embodiment of the present invention.

In a particularly preferred example embodiment, the valve seat is essentially annular and, in particular, has a mirror-symmetrical cross-section. Because the valve seat is preferably annular, the actuator can move into the valve seat without coming into contact with a valve seat surface. In particular, the valve seat may also have a mirror-symmetrical cross-section, so that the valve seat can act identically on both sides.

In another preferred example embodiment, the valve seat is a seal.

In a further example embodiment, the outer surface of the valve seat includes a circumferential groove, wherein the groove serves to accommodate a sealing element such as, for example, an O-ring. The sealing element can, for example, improve the sealing effect and/or hold the valve seat in position.

In a further particularly preferred example embodiment, at least one, in particular, both axial end surfaces of the valve seat have a, in particular circumferential, recess or groove. The groove causes the applied pressure on the valve seat to be distributed radially inward and outward to support the sealing effect when pressure is applied. This also prevents the pressure from acting exclusively in the axial direction on the valve seat, which could potentially crush the valve seat or cause it to slip. In the case of a mirror-symmetrical valve seat, the groove may be arranged identically on both end surfaces of the valve seat.

In a further example embodiment, a sealing lip is defined by the recess or groove. The sealing lip can then be pressed against the actuator or the housing wall by the applied pressure in the manner described above, which further enhances the sealing effect.

In a further preferred example embodiment, the valve seat includes, on a radially inner side, at least one, in particular two, circumferential projections that define a sealing nose. This sealing nose may be arranged such that the applied pressure, via the recess on the end surface, presses the sealing nose against the actuator to further enhance the sealing effect.

In a particularly preferred example embodiment, the valve seat is made of a high-performance plastic, specifically PEEK. This material meets the high requirements for sealing performance, strength, processability, and coefficient of friction, making the valve seat suitable even for high pressures, particularly those of hydrogen.

An example embodiment of the present invention also relates to a support ring for a valve according to an example embodiment of the present invention.

In an example embodiment of the present invention, the support ring includes a circumferential first section extending in the axial direction, including at least one radially inner surface and at least one radially outer surface, wherein the radially inner surface extends substantially parallel to the longitudinal axis of the support ring, and at least one radially outer surface extends at an angle greater than 0°, in particular between about 10° and about 80°, for example, to the longitudinal axis of the support ring. An angle of, for example, about 45±10° is particularly suitable. Such support rings are known and commercially available. In particular, such support rings are available with matching groove rings. According to an example embodiment of the present invention, the support ring additionally includes at least a second section extending in the axial direction, in particular a cylindrical section, wherein an outer diameter of the second section is greater than a maximum outer diameter of the first section. This at least second section of the support ring may be

dimensioned such that it abuts, for example, against a housing wall on the outer side and against the actuator on the inner side. Thus, in addition to its support and retaining functions with respect to the groove ring, the support ring also serves as a guide for the actuator.

In a further example embodiment, the first section of the support ring can be inserted or slid into a receptacle of a groove ring. In particular, the first section may be dimensioned such that it is compatible with conventional groove rings available on the market.

In a further example embodiment, the second section includes a first contact surface to engage a groove ring. In this way, the support ring can also support a mounted groove ring in the axial direction.

In a further example embodiment, the second section includes a second contact surface for contact with a wall in a valve housing. In this way, the support ring can be supported in the axial direction by a wall of the housing.

Below, several example embodiments of the present invention are described in more detail with reference to the figures. Of course, the present invention is not limited to the example embodiments shown.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A shows a cross-section through a valve according to an example embodiment of the present invention.

FIG. 1B shows the same valve as in FIG. 1A in the open state.

FIG. 2 shows a cross-section of the valve shown in FIG. 1A in a different view.

FIG. 3 shows a detailed view of the valve seat and the sealing material of the valve shown in FIGS. 1A and 1B.

FIG. 4 shows an exterior view of the valve shown in FIGS. 1A and 1B.

FIG. 5A shows a cross-section of a valve seat according to an example embodiment of the present invention.

FIG. 5B shows a perspective view of the valve seat shown in FIG. 5A.

FIG. 6A shows a cross-section of a sealing element including a support ring and a groove ring according to an example embodiment of the present invention.

FIG. 6B shows a perspective view of the support ring shown in FIG. 6A.

FIG. 7A shows a cross-section of another valve according to an example embodiment of the present invention in two different views.

FIG. 7B shows a cross-section of the valve shown in FIG. 7A in the open position.

FIGS. 8A to 8C show a schematic example embodiment of a valve configured as a 3/3-way valve, in three different operating positions.

FIGS. 9A to 9C show a schematic example embodiment of a valve configured as a 3/3-way valve, with an actuator having bores in its wall, in three different switching positions.

FIGS. 10A and 10B show a variant of an actuator with openings of different sizes in two switching positions.

FIGS. 11A and 11B show a further variant of an actuator with non-rotationally symmetric openings.

FIGS. 12A and 12B show a further variant of an actuator that can be rotated into different switching positions.

FIG. 12C shows a schematic representation of a sealing device for a rotary actuator.

### DETAILED DESCRIPTION OF THE EXAMPLE EMBODIMENTS

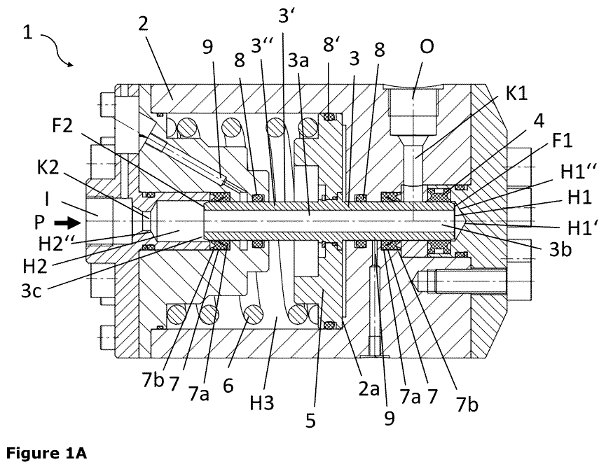

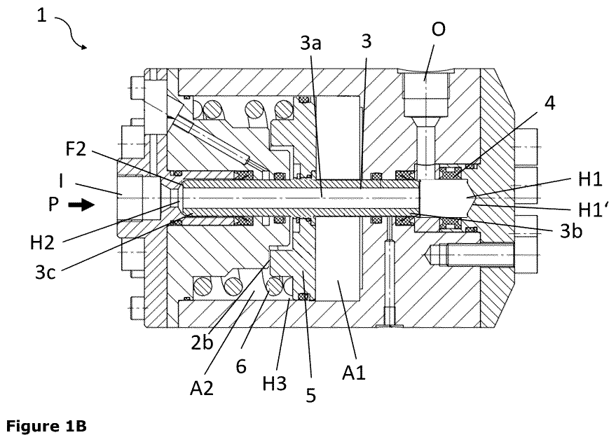

FIG. 1A shows a cross-section of a valve 1 according to an example embodiment of the present invention. The valve 1 includes a housing 2 including an inlet I and an outlet O. An actuator 3 in the form of a hollow cylinder is arranged within the valve 1. The actuator has a wall 3′′ with an outer surface 3′. A channel 3a is arranged within the actuator 3 so that a medium can flow through the actuator 3. In the configuration shown, the valve 1 is closed and the actuator 3 is in a first end position. In this configuration, the first end 3b of the actuator 3 is located in a first recess H1 of the housing 2. Correspondingly, the second end 3c of the actuator 3 is located in a second recess H2 of the housing 2. The recesses H1 and H2 are connected via channels K1 and K2 to the outlet O and the inlet I, respectively.

The first end 3b of the actuator 3 is located in a ring-shaped valve seat 4, which seals the channel 3a of the actuator 3 against the outlet O. The valve seat 4 thus forms a seal in this case. The valve 1 is consequently closed, and no medium can flow from the inlet I to the outlet O. The valve 1 shown is laterally configured, meaning that the outlet O and the inlet I are not on a common axis. It should be noted again that the valve can also be designed as a coaxial valve, which requires a suitable deflection of the inlet I or the outlet O. As already mentioned, a deflection has hardly any disadvantages, particularly when using light gases such as hydrogen. In some cases, the advantages of a coaxial arrangement may outweigh the disadvantages of a deflection.

The recess H1 has a conical end wall H1′ created by a bore, such that a first end surface F1 of the actuator 3 does not contact the inner wall H1″ of the recess H1 but remains essentially free. A pressure P is applied at the inlet I of the valve 1. Because the end surface F1 of the actuator 3 is exposed, the pressure P acts uniformly on the end surface F1 and a second, opposite end surface F2 of the actuator 3. Consequently, no net pressure acts in the axial direction on the actuator 3, neither in the shown closed state nor in the shown open state of the valve 1. The actuator 3 is thus pressure-relieved at all times with respect to the applied pressure P.

A piston 5 to adjust the actuator 3 is also arranged on the actuator 3. The piston 5 is arranged in a third recess H3 of the housing 2 so as to be adjustable and is held in the shown first end position by a spring 6. The shown valve 1 is thus normally closed. Of course, the valve 1 can also be designed to be normally open. The piston 5 rests against a housing wall 2a, which thus defines the first end position of the actuator 3.

Additional sealing elements are arranged along the actuator 3, each sealing the recesses H1, H2, and H3 from one another. The sealing elements shown in FIGS. 1A and 1B are fixedly mounted in the housing 2, so that they are stationary relative to the actuator 3. Of course, sealing elements that are fixed to the actuator 3 may also be, for example, piston seals.

The sealing elements shown are sealing elements 7 with a support ring 7a and a groove ring 7b according to an example embodiment of the present invention. Furthermore, the valve 1 shown has additional sealing elements in the form of O-rings 8, 8′. A channel 9 to monitor and measure leaks is arranged between each of the O-rings 8 and the sealing elements 7. The O-ring 8′ is arranged on the piston 5 and seals the two working chambers A1, A2 of the recess H3 off from one another.

FIG. 1B shows the same valve as FIG. 1A, but actuator 3 is in its second end position. Valve 1 is thus open. To achieve this, a pressurized medium was directed into a working chamber A1 of recess H3, causing piston 3 to move within the third recess H3 against the spring force of spring 6 until piston 5 came into contact with a housing wall 2b. The working chamber A2 of recess H3 has thereby decreased in size. The first end 3b of the actuator has been moved out of the valve seat 4, so that the channel 3a of the actuator 3 is connected to the outlet O. The valve 1 is thus open.

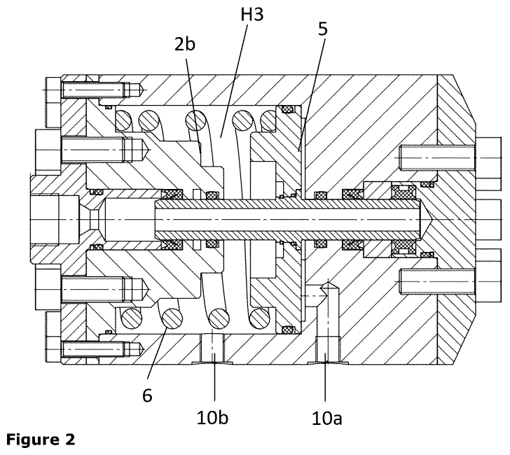

FIG. 2 shows the same valve 1 as in FIG. 1A from a different angle. The illustration shows two channels 10a, 10b, which serve to fill the working chambers A1, A2 of the recess H3 with a control medium. In the position shown, the valve 1 is closed. To open it, a control medium such as a gas is conveyed through channel 10a, causing the piston 5 to move in the axial direction against the spring force of spring 6 until the piston disc 5 comes into contact with a wall 2b of the housing 2, as shown in FIG. 1B. This defines the second end position of the actuator 3. When the piston 5 is moved, pressure medium must simultaneously be discharged from working chamber A2 through channel 10b. To close valve 1, it is sufficient to either relieve the pressure from channel 10a so that spring 6 moves piston 5 to its initial position, or to additionally supply pressurized control medium into channel 10b to assist or accelerate the closing process. The channels 10 and 10b preferably serve as both inlets and outlets.

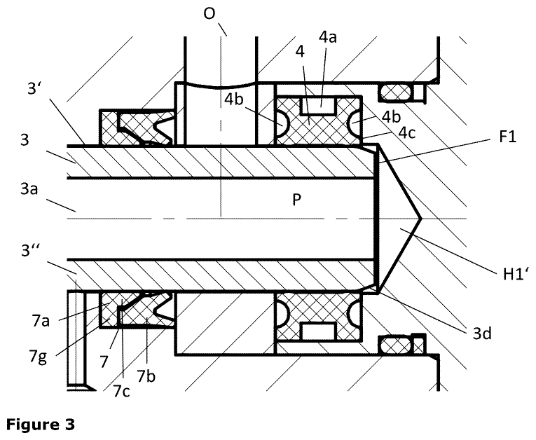

FIG. 3 shows a detailed view of the valve seat 4 and the actuator 3 arranged therein. The actuator 3 rests with its outer surface 3′ against the valve seat 4. In the closed position shown, the valve seat 4 seals channel 3a off from the outlet O. At the same time, the conical end wall H1′ ensures that the first end surface F1 is exposed. The pressure P acting at the inlet I thus acts equally on the first end surface F1 and the opposite end surface F2 (not shown). The actuator 3 is thus pressure-relieved even when valve 1 is in the closed position, meaning that comparatively low switching forces are sufficient to operate the valve even at high applied pressures. Since the actuator 3 does not come into contact with a surface of a valve seat, as in previously known solutions, the problem of wear on the contact surface is also eliminated. Thus, the valve 1 according to the present example embodiment is also suitable for particularly thin gases such as hydrogen, even and especially at high pressures. If the actuator 3 is moved as described above and moved out of the valve seat 4, the outlet O is connected to the channel 3a and thus to the inlet I, and the valve 1 is thereby opened.

The valve seat 4 has a circumferential groove 4a that serves to accommodate an O-ring (not shown), which stabilizes the valve seat 4 and can improve the sealing effect. Circumferential recesses in the form of a groove 4b are arranged on both end surfaces of the valve seat 4, whereby the end surfaces include sealing lips 4c. When pressure is applied to the end surfaces, the pressure is redirected toward the sealing lips 4c, thereby enhancing the sealing effect by pressing the sealing lips 4c against the outer surface 3′ of the actuator 3 or against a wall of the housing 2.

Furthermore, the ends 3b, 3c of the actuator 3 include a tapered section 3d to prevent damage to the valve seat 4 when the actuator 3 is extended and retracted.

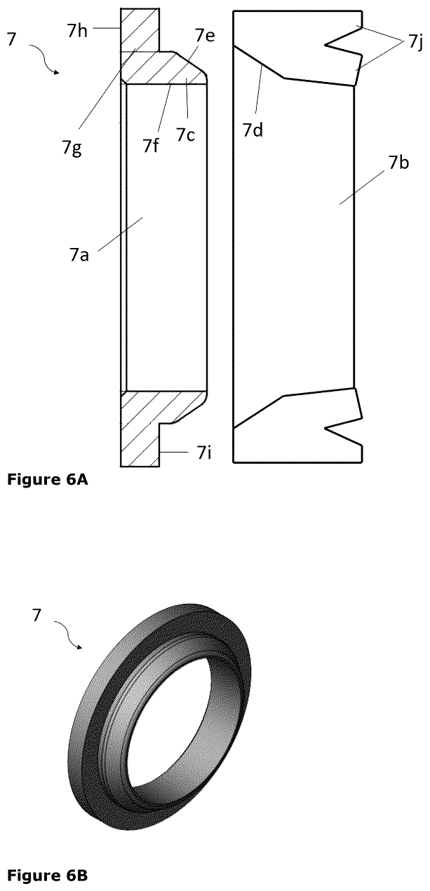

Also shown in FIG. 3 is a sealing element 7 including a support ring 7a and a groove ring 7b mounted thereon. The support ring 7a includes a section 7g whose outer diameter is larger than the outer diameter of an adjacent conical section 7c. The support ring 7a thus serves as a guide on one side and as a support for the groove ring 7b on the other side. The exact design of the support ring is described in greater detail in connection with FIGS. 6A and 6B.

The groove ring 7b is a seal made of H-ECOPUR with two sealing lips. When valve 1 is opened, the seal 7 seals the recess H1 against the recess H3, with the sealing lips being pushed apart by the pressure. At the same time, the support ring 7a stabilizes the groove ring 7b so that it does not slip or become compressed. It has been demonstrated that this configuration withstands many thousands of switching cycles at very high pressures of 1000 bar and above, particularly when hydrogen is used, and operates reliably.

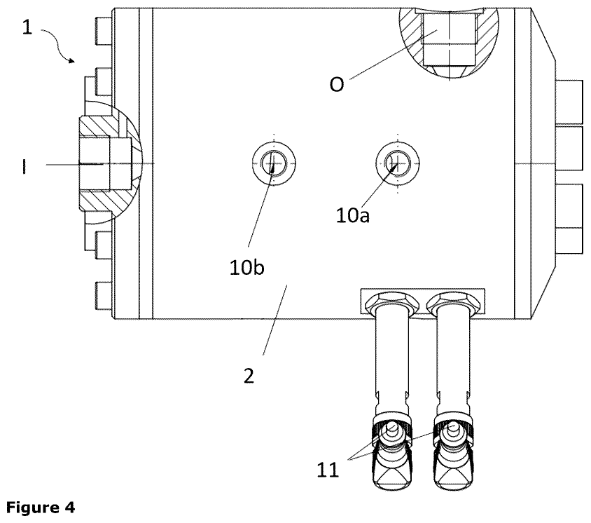

FIG. 4 shows an exterior view of the valve 1 with the cylindrical housing 2 and the inlet I and outlet O. The control connections to channels 10a, 10b are also visible on the side wall of the housing 2. Furthermore, the contacts 11 for a limit switch (not shown) are also depicted.

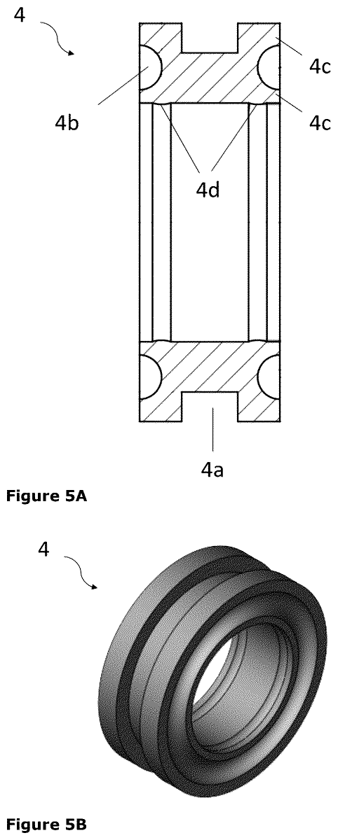

FIG. 5A shows a cross-section through a valve seat 4 according to an example embodiment of the present invention. On the outer surface, the valve seat 4a features a circumferential groove 4a configured to receive an O-ring. The two end surfaces also feature circumferential recesses 4b to distribute the applied pressure. The recesses 4b are arranged such that the end surfaces of the valve seat feature sealing lips 4c, which are pressurized when pressure is applied and support the sealing action of the valve seat 4. Furthermore, the valve seat 4 features two projections 4d on a radially inner side, which define sealing noses and, when assembled, bear against the actuator 3. The sealing noses are pressed against the outer surface 3′ of the actuator 3 when pressure is applied.

FIG. 5B shows a valve seat 4 according to an example embodiment of the present invention in a perspective exterior view.

FIG. 6A shows a cross-section through a support ring 7a of a sealing element 7 according to an example embodiment of the present invention. Next to it is shown a groove ring 7b, which is slipped onto the support ring 7a when assembled. The support ring 7a includes a first section 7c extending in the axial direction. Section 7c is inserted into the receptacle 7d of the groove ring 7b. Radially on the outside, the first section 7c also includes an inclined surface 7e. Radially on the inside, the support ring 7a has a surface 7f extending parallel to the longitudinal axis of the support ring 7a. This surface 7f abuts against the outer surface 3′ of the actuator 3.

Additionally, according to an example embodiment of the present invention, the support ring 7a includes a second section 7g whose outer diameter is larger than the largest outer diameter of the first section 7c. The second section 7g is dimensioned to define a guide between a housing wall and the actuator 3. The second section 7g also includes a surface 7h that abuts against a housing wall and a surface 7i against which the groove ring 7b abuts. Due to the aforementioned features, the support ring automatically centers itself between the housing 2 and the actuator 3 and simultaneously stabilizes the groove ring 7b, so that the latter forms a reliable seal. The groove ring 7b is a commercially available groove ring with two circumferential sealing lips 7j.

FIG. 6B shows a support ring 7b according to an example embodiment of the present invention in a perspective exterior view.

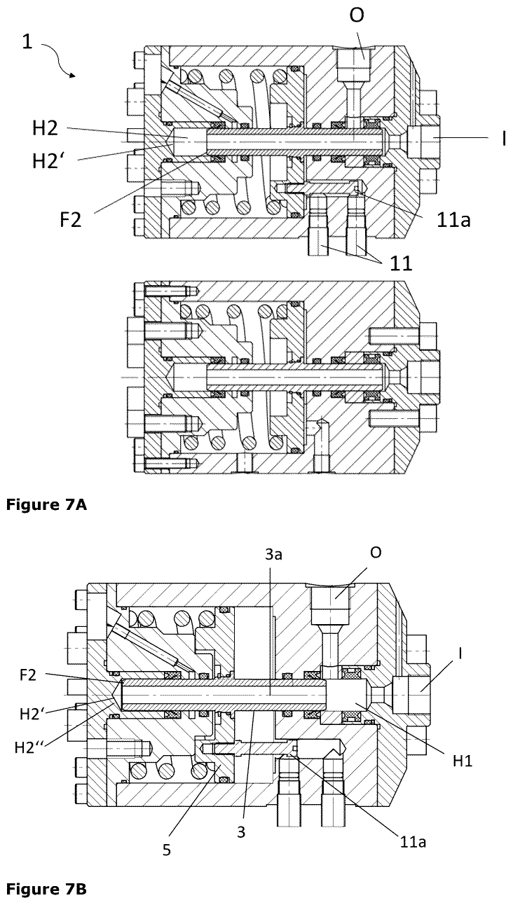

FIG. 7A shows another example embodiment of a valve 1 according to an example embodiment of the present invention in two different cross-sectional views. The features largely correspond to the example embodiment shown in FIG. 1A. Only the inlet I is arranged on the opposite side of the valve 1, so that the distance between the inlet I and the outlet O is significantly shorter than in the example embodiment shown in FIG. 1A. Accordingly, the second recess H2 of the housing 2 includes a conical end wall H2′ so that the actuator 3 is pressure-relieved in the second end position, i.e., in the open state. Consequently, the end surface F2 of the actuator 3 is exposed in the second end position. The limit switch 11a detects via the contacts 11 whether the valve is closed or open.

FIG. 7B shows the valve from FIG. 7A in the open position. The actuator 3, together with the piston 5, is moved to its second end position in a manner analogous to the position shown in FIG. 1B. In the position shown, the inlet I and the outlet O are directly connected to each other via the recess H1. That is, the medium does not first have to flow through channel 3a of the actuator 3 to reach the outlet O from the inlet I. The second end surface F2 of the actuator 3 remains free due to the conical end wall H2′ of the recess H2 and does not contact the inner wall H2′. The actuator 3 is thus also pressure-relieved in this position. The limit switch 11a is now connected to the other contact and thus detects that the valve 1 is open.

This example embodiment has the advantage that the nominal diameter of the valve is determined not by channel 3a in actuator 3, but by recess H1. Recess H1 has a diameter corresponding to the outer diameter of actuator 3. The nominal diameter of the valve shown thus no longer depends on control tube 3 or its inner diameter. If one were to enlarge channel 3a in the actuator in the example embodiment shown in FIG. 1A in order to increase the nominal diameter of the valve, the actuator 3 would have to be correspondingly more robust and the outer wall 3″ correspondingly thicker to counteract destruction or deformation of the control tube. As a result, the control tube, and thus the valve, would very quickly become very large, expensive, and impractical, or might even be impossible to manufacture under certain circumstances.

In the shown example embodiment, channels K1 and K2 are narrower than recess H1. The flow velocity within the valve is thus reduced. It should be noted that channel 3a within actuator 3 is provided to ensure that actuator 3 is pressure-relieved. However, the diameter of channel 3a is irrelevant in this context. In particular, channel 3a is not significant for the nominal diameter of the valve.

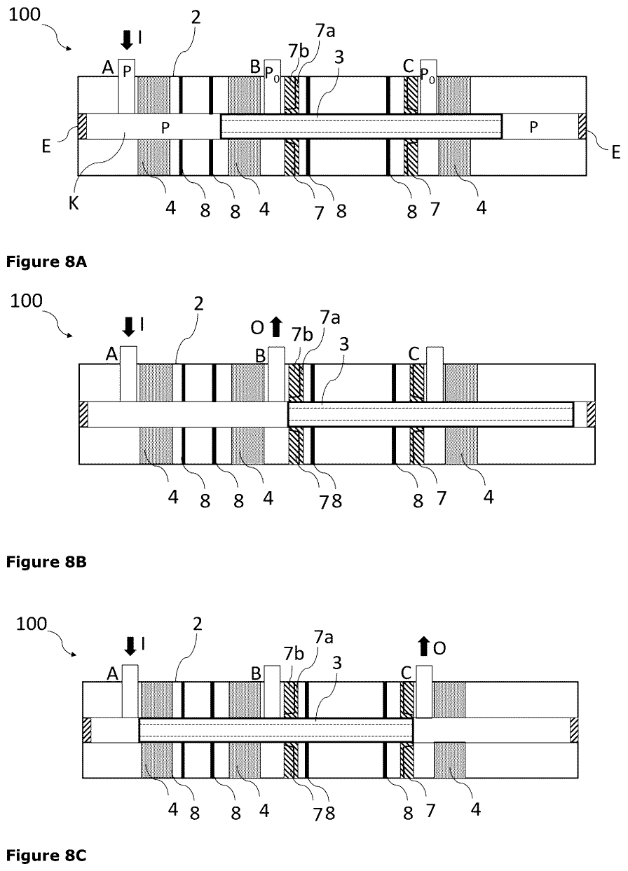

Another possible example embodiment of a pressure-relieved valve 100 according to an example embodiment of the present invention is schematically illustrated in FIGS. 8A-8C. The actuator 3, the valve seats 4, the seals 8, and the sealing elements 7, 7a, 7b are, in principle, identical to the corresponding components described above in the previously described example embodiments. Unlike the example embodiment shown in FIG. 1A, the example embodiment shown here is a 3/3-way valve, meaning it has three ports A, B, C and three switching positions. Port A can, for example, function as an inlet I, and the two ports B and C as an outlet O. The channel K is closed at both of its ends E.

The first valve position is shown in FIG. 8A, with valve 100 closed in this position. A pressure P is applied at the inlet O (port A), which is distributed via the tubular actuator 3 from the left section inside the housing 2 to the right section inside the housing and acts on the valve seat 4 to the right of port C. A pressure P₍₀₎ is applied at ports B and C, where P>P₀. The valve seat 4 thus seals port C off from port A in the manner described in connection with the previous example embodiment, so that no fluid can flow from the inlet I to the outlet O.

In the same manner, the valve seat 4 to the left of port B, which is also subjected to the pressure P from port A, seals port B against port A. Between ports B and C, there are no valve seats 4, but rather sealing elements 7 of the type described above, including a support ring 7a and a groove ring 7b, in which the actuator 3 is slidably mounted or adjustably arranged, with the actuator 3 being positioned within the sealing elements 7 in every switching position. For additional support, two seals 8 in the form of O-rings are arranged between ports B and C and between ports A and B, respectively. An additional valve seat 4 is arranged next to port 4.

The actuator 3 can be adjusted to two additional positions using an adjustment device (not shown). The adjustment device can essentially be any suitable adjustment device, in particular a pneumatic, hydraulic, or magnetic adjustment device. Naturally, depending on the design of the adjustment device, the valve 100 can be configured to be normally open or normally closed.

FIG. 8B shows the valve 100 in the second switching position. The adjustment mechanism (not shown) has moved the actuator 3 to the right. Port B has thus been opened, while port C remains closed. Port C is sealed by the left of the two sealing elements 7 shown in FIG. 8B and the additional seals 8 between ports B and C and the valve seat 4 to the right of port C. In the shown switching position, port A thus defines the inlet I and port B defines the outlet O of valve 100.

FIG. 8C shows a third switching position of valve 100. The actuator 3 has been moved by the actuating device (not shown) into a third position in which port B is sealed off from ports A and C. The fluid flow can thus proceed from port A to port C, which defines the outlet O. The actuator 3 has thus been moved into the valve seat 4 on the left side of FIG. 8C. Port B is thus sealed by the left valve seat 4 and the sealing element 7 on the right side of the figure.

In all switching positions, the actuator 3 is seated in the two sealing elements 7 or is arranged therein so as to be longitudinally movable. In contrast, the actuator 3 is retracted from at least one valve seat 4 in every switching position.

Of course, the example embodiment shown in FIGS. 8A-8C can also be designed as a 3/2-way valve, in which the actuator 3 can only be moved between two switching positions. For example, only the two switching positions shown in FIGS. 8B and 8C could be adjustable, such that the valve 100 switches between the two ports B and C, with one of the two ports B or C defining an open outlet O in exactly one switching position. In this configuration, valve 100 would never be closed but could switch the fluid flow from A to B or to C. The valve seat 4 shown in the center of the figure could then be omitted.

Other configurations can also be implemented in example embodiments of the present invention. For example, 5/3-way valves are possible. Furthermore, the arrangement and number of valve seats 4, sealing agents 7, and seals 8 can be varied depending on the requirements, pressure, and connection configuration, and adapted to the respective conditions. The example embodiments shown are therefore in no way limiting, but are intended merely to schematically illustrate how a multi-way valve with a valve seat 4 or sealing element 7 according to an example embodiment of the present invention can be constructed and configured.

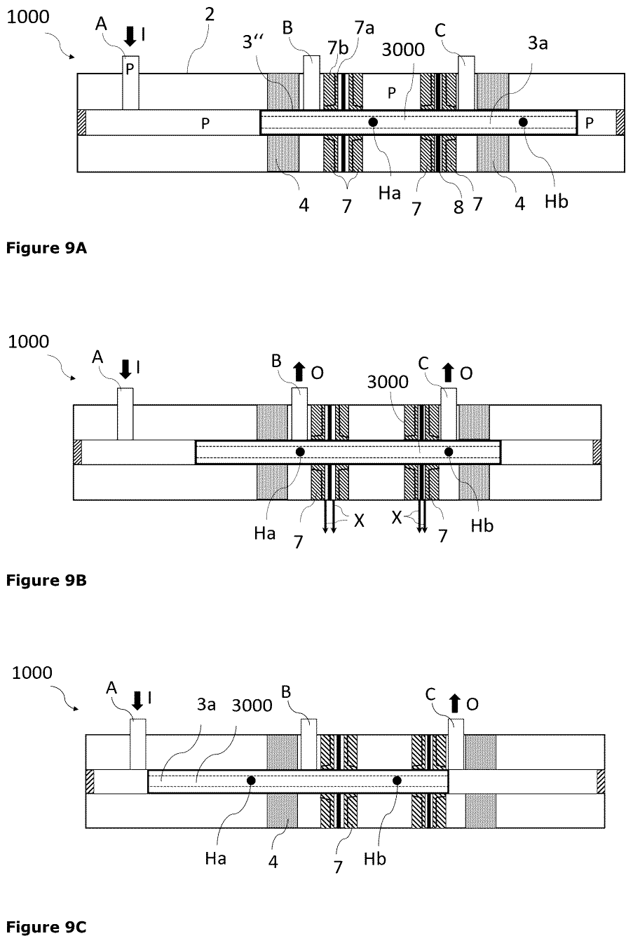

A further possible example embodiment of a valve 1000 is shown in FIGS. 9A and 9B. The valve seats 4, the sealing elements 7, and the seals 8 correspond here as well to the components described above. In contrast to the example embodiments described above, however, the actuator 3000 additionally features two bores Ha, Hb in its wall 3″, through which the fluid flow can also exit laterally from channel 3a.

In FIG. 9A, the valve 1000 is closed. A pressure P is applied to port A, which is directed through channel 3a of the actuator 3000 into the section to the right of port C, as in the previously described example embodiment. The valve seats 4 seal each of the ports B and C relative to port A. In contrast to the example embodiment shown in FIGS. 8A-8C, the pressure P is distributed via the opening or bore Ha additionally into the central region of the housing 2, which lies between ports B and C. Therefore, ports B and C are each sealed relative to port A via the sealing elements 7 and seals 8 arranged in this region. In particular, the two sealing elements 7 in the center of the four shown in the figure are responsible for sealing ports B and C, as their O-rings 7b are each oriented toward the pressure side P in the manner described above. Since the actuator 3000 does not leave or exit the valve seat 4 on the left in the figure in any of the switching positions, this valve seat 4 could also be replaced by a sealing element 7.

Other combinations/arrangements/numbers of seals 8, sealing elements 7, and valve seats 4 are conceivable, possible, and potentially advantageous, so that the valve 1000 can be adapted to the pressures used and the requirements regarding tightness.

FIG. 9B shows the same valve 1000 as in FIG. 9A, but the actuator 3000 has been moved to a second switching position by an adjustment device (not shown). The two bores Ha and Hb are now aligned with ports B and C, allowing fluid flow from port A to ports B and C. In the position shown, port A thus forms the inlet I, and ports B and C each form an outlet O for valve 1000.

The two of the four sealing elements 7 located on the outside in the figure seal port B off from port C. Depending on the configuration of the ports, particularly when the flow rates through ports B and C are equal and the applied pressure is the same, these two sealing elements 7 may be redundant or unnecessary and can be omitted or replaced by conventional sealing elements, depending on whether the sealing effect at this position is required for the operation of valve 1000 or not.

In the case of very high pressures P, when the holes Ha and Hb pass over the two sealing elements 7 arranged side by side and rotated 180° relative to each other, pressure P may be applied between the two sealing elements 7. In this case, high pressure P is applied to the side of the sealing elements 7 not intended for this purpose, namely the side of the support ring 7a and not the side of the groove ring 7b. A possible solution to this problem may be to depressurize the valve 1000 when this transition occurs. It is also conceivable and possible that at least one equalization channel X exists between these sealing elements to equalize or release the excess pressure P between the two adjacent sealing elements 7. This at least one equalization channel X can and, if necessary, must be closable.

In FIG. 9C, the actuator 3000 is set to a third switching position. Bore Ha is located in the same housing section as port A and therefore has no function in this switching position. Through bore Hb, the pressure is again directed into the housing section between the two ports B and C. Port B is sealed off from port A via the valve seat 4 on the left side of the figure and, as described in connection with FIG. 9A, by the sealing compound 7 (marked with a reference symbol in FIG. 9C). Consequently, no fluid flows from port A to port B.

In this position, flow from port A to port C is possible through channel 3a of the actuator 3000. Port C thus defines an outlet O in this position. The present example embodiment is therefore also a 3/3-way valve with three ports and three positions.

Of course, this example embodiment is also variably adaptable. For example, the number and arrangement of the ports, the switching positions, the sealing elements, and the valve seats can be varied. For example, the valve may also be configured as a 3/2-way valve with only two switching positions. The valve 100, 1000 may also be designed as a coaxial valve by leaving the ends E open. In this case, by adjusting the actuator 3, 3000, for example, the side ports A, B, C can be switched on or off, with the ends E each forming a normally open inlet I or outlet O.

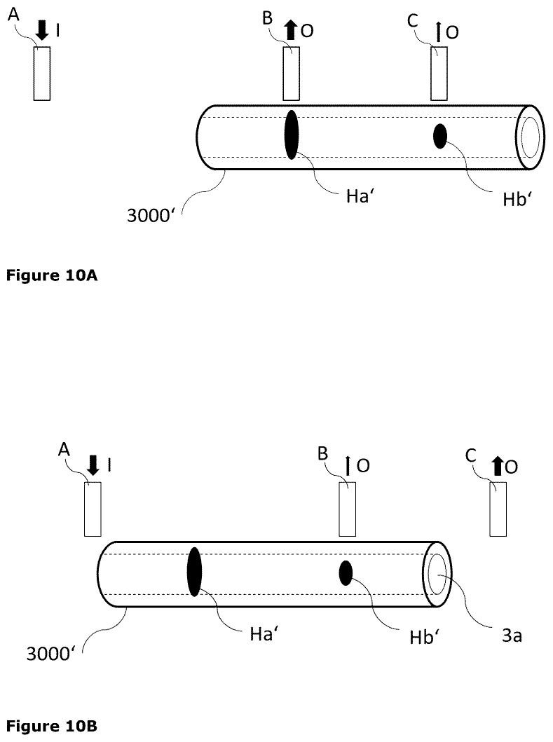

An example of a further possible variant of an actuator 3000′ is shown in FIGS. 10A and 10B. For the sake of clarity, the remaining components of the valve are not shown, and the positions of the ports A, B, C are only indicated. The actuator 3000′ has several bores Ha′, Hb′ and is otherwise configured as described in the previous example embodiments. In the operating position shown in FIG. 10A, the first bore Ha′ is at the level of port B and the second bore is at the level of port C. The fluid flow can thus flow from port A to both port B and port C.

The cross-sectional area of the first bore Ha′ is larger than that of the second bore Hb′. The flow rate to port B is thus greater than the flow rate to port C (indicated by the arrows of different sizes).

FIG. 10B shows the same actuator in a second switching position, with the second bore Hb′ aligned with port B. This means that the flow rate to port B is lower in this switching position than in the first switching position. In contrast, the fluid flow from port A to port C is possible through channel 3a in this position, so that the flow to port C is greater in this position than in the first position. It is thus a 3/2-way valve, wherein the two positions regulate the flow to ports B and C. Of course, this example embodiment can also be adapted to include additional switching positions, such as an additional “closed” switching position.

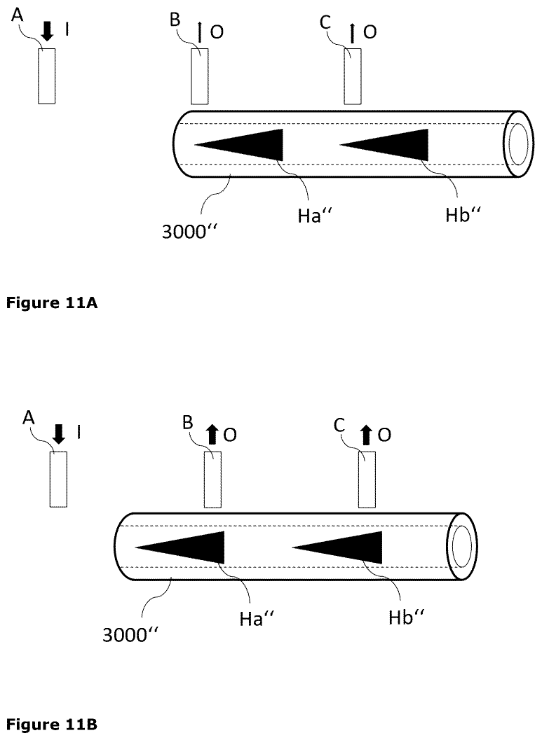

Another alternative for an actuator 3000 is shown in FIGS. 11A and 11B. The two bores Ha″ and Hb″—or openings—are not circular or rotationally symmetric, but are essentially triangular in shape. In the switching position shown in FIG. 11A, only the tips of the triangles are aligned with one of the ports B or C. The flow to ports B and C is therefore comparatively low. In the switching position shown in FIG. 11B, the wide ends of the triangles are at the level of ports B and C, and the flow to ports B and C is correspondingly greater. Of course, intermediate switching positions are also possible, as is a gradual, stepless adjustment of the actuator 3000″. Among other things, however, not exclusively—with the shown example embodiment, various variants of metering and control valves are thus possible.

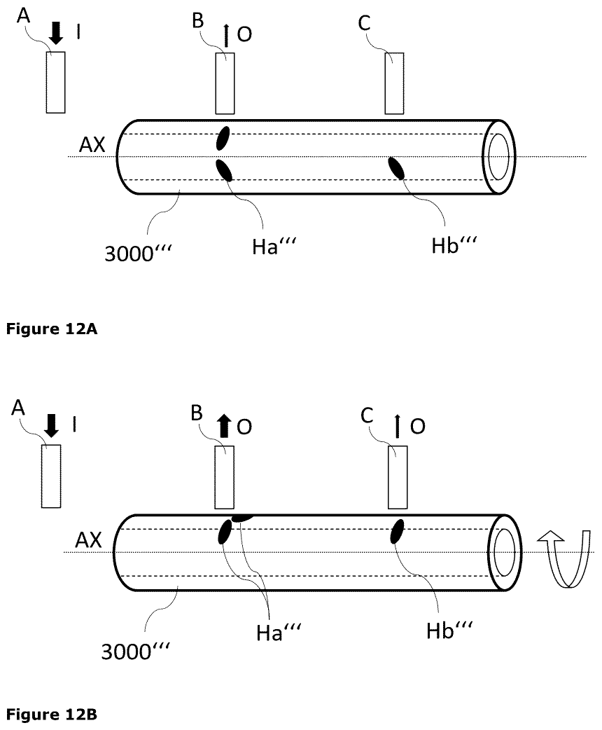

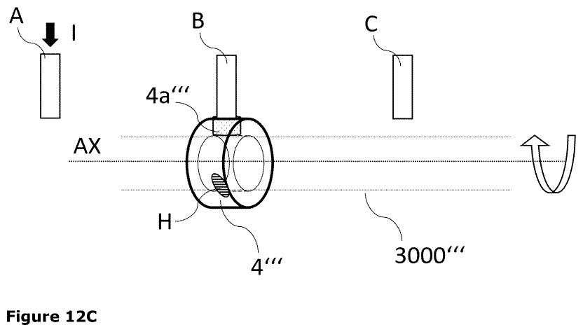

Another alternative for an actuator 3000″ is shown in FIGS. 12A and 12B. The opening Ha″ includes two bores arranged side by side in the circumferential direction. The opening Hb″ includes only one bore. In the shown switching position, the upper bore of the opening Ha″″ in the figure corresponds to connection B. For this purpose, for example, a channel corresponding to connection B may be provided in a sealing elements not shown, which seals the lower of the two bores in the figure relative to connection B and connects the bore arranged above it in the figure to connection B. In the shown switching position, connection B thus defines an outlet O with a comparatively low flow rate.

Unlike in the previously described variants, the actuator 3000″′ is moved into a second switching position by rotation about its longitudinal axis AX. In FIG. 12B, the actuator 3000″′ is in a second switching position. In this switching position, both bores of the opening Ha″′ correspond to port B, whereby the corresponding channel in the sealing medium (not shown) must be configured such that it connects both bores of the opening Ha″′ to port B. The flow rate to port B is thus greater than in the first switching position.

In this switching position, the second opening Hb″′ corresponds with one of its bores to connection C. Connection C thus also forms an outlet O in this switching position. Since this opening Hb″′ has only one bore, the flow rate is lower than at connection B. Of course, variants are also possible in which both openings Ha″′, Hb″′ are of the same type, so that the valve has a closed position and a position in which both ports B and C are open. It is also possible for both openings to be of the same type but aligned in a circumferential direction offset from one another. In this way, the valve can, for example, have three switching positions, with the valve being closed in the first switching position. In the other two switching positions, one of the connections B or C is open, with the flow rate of the two connections being the same in the respective open switching position.

Of course, this variant can also be modified and adapted to different switching positions and connection configurations.

FIG. 12C schematically shows an example of a sealing element 4′″, which can be used in conjunction with the actuator 3000″. The sealing element 4″′ resembles a valve seat 4 or a circumferential sealing ring and is fixedly arranged in the area of port B. The sealing element 4″ features a channel 4a″ that corresponds to connection B. A bore H, which is located on the actuator 3000″ (shown only schematically), can be connected to channel 4a″ or sealed off from channel 4a″ by rotating the actuator 3000″. A similar sealing element 4″ with a channel of the same type or with a different cross-section may or must also be arranged in the area of connection C.

Of course, the technical features described above and the associated advantages can be combined in a technically meaningful manner. Example embodiments of the present invention can thus be adapted to a wide variety of requirements, pressures, and connection configurations. Alternatively, instead of multiple outlets O, multiple inlets I may be provided. The valve may also include multiple inlets I and multiple outlets O, which can be interconnected in various ways through suitable variations of the above technical features.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A valve comprising
at least one inlet;
at least one outlet;
a housing;
an actuator located in the housing and adjustable to at least a first end position in which the valve is closed, and to at least a second end position in which the valve is open; and
a controller to adjust the actuator; wherein
the actuator includes a tubular body including a wall defining two ends and an outer surface, and an axially extending channel that opens at each of the two ends, the first end of the actuator sealingly fits into a first recess of the housing in both the first and the second end positions, and the second end of the actuator fits sealingly into a second recess of the housing in both the first and second end positions;
connection channels terminate in the first and second recesses and connect to connecting channels that connect the first and second recesses to the inlet and the outlet;
the valve further comprises a valve seat including a substantially annular body to receive the actuator, and which, in the first end position in which the valve is closed, bears sealingly against the outer surface of the actuator.

2. The valve according to claim 1, wherein the first and second ends of the actuator do not come into contact with inner walls of the first and second recesses.

3. The valve according to claim 1, wherein the valve seat is located in the first recess.

4. The valve according to claim 1, wherein the valve seat bears sealingly against the outer surface of the actuator in the first end position, and the first end of the actuator is displaced out of the valve seat in an axial direction in the second end position, such that the connection channels of the actuator communicate with the connecting channels.

5. The valve according to claim 1, wherein the actuator is adjustable by a drive.

6. The valve according to claim 5, wherein the actuator includes a piston connected to the actuator and located in a third recess of the housing to seal off two working chambers from one another, and the piston is movable back and forth between end positions by a control medium in the working chambers.

7. The valve according to claim 6, wherein in the first end position and the second end position of the actuator, the body of the actuator rests against a surface within the third recess to limit an axial adjustability of the actuator.

8. The valve according to claim 6, further comprising a seal to seal off the third recess from the first and second recesses.

9. The valve according to claim 1, further comprising at least one sealing element including a support ring and a groove ring, wherein the actuator is adjustably arranged in the at least one sealing element.

10. The valve according to claim 9, wherein the at least one sealing element is a piston seal on the actuator.

11. The valve according to claim 9, wherein the groove ring includes a polyurethane.

12. The valve according to claim 1, wherein the valve seat includes a high-performance plastic.

13. The valve according to claim 1, wherein the valve is a coaxial valve, a 3/2-way valve, a 3/3-way valve, a metering valve, or a control valve.

14. The valve according to claim 1, wherein the inlet is usable as an outlet, and the outlet is usable as an inlet.

15. The valve according to claim 1, further comprising at least one additional channel that terminates between two sealing elements in a region of one of the first recess and the second recess to monitor and measure leaks.

16. The valve according to claim 1, further comprising a spring directly or indirectly operatively connected to the actuator to hold the actuator in the first or second end position.

17. The valve according to claim 1, wherein the actuator includes a magnet.

18. The valve according to claim 1, wherein the actuator includes at least one opening with a non-rotationally symmetric cross-section, or the actuator includes at least two openings with different cross-sectional areas.

19. The valve according to claim 1, wherein the actuator is adjustable from a first switching position to at least a second switching position by rotation about a longitudinal axis thereof.

20. The valve according to claim 1, further comprising a sealing element including at least one channel.
